(19) United States
(12) Patent Application Publication
(10) Pub. No.: US 2026/0349257 A1
(43) Pub. Date: Nov. 5, 2026

(54) OPTICAL OUTCOUPLING COMPONENT, WAVEGUIDE DEVICE AND METHOD FOR MANUFACTURING SAID OPTICAL OUTCOUPLING COMPONENT

(71) Applicant: UNIVERSITEIT GENT, Gent (BE)

(72) Inventors: Kristiaan NEYTS, Gent (BE); Inge NYS, Gent (BE); Brecht BERTELOOT, Gent (BE); Migle STEBRYTE, Gent (BE)

(21) Appl. No.: 19/486,111

(22) PCT Filed: Jun. 3, 2024
(86) PCT No.: PCT/EP2024/065167

§ 371 Date: Nov. 20, 2025

(30) Foreign Application Priority Data
Jun. 5, 2023 (EP) 23177203.9

(51) Int. Cl. G02B 27/01

(52) U.S. Cl. CPC G02B 27/0172

(57) ABSTRACT

An optical outcoupling component is configured to couple light out of a waveguide device. The outcoupling component includes at least one substrate and at least one optically active layer. The at least one optically active layer includes first areas configured to transmit light without outcoupling, and second areas configured to outcouple at least part of the light.

### FIELD OF THE INVENTION

The present invention generally relates to an optical outcoupling component, a waveguide device including said optical outcoupling component and a method of manufacturing said optical outcoupling component.

### BACKGROUND OF THE INVENTION

Optical devices, for example portable and wearable devices, for augmented reality are increasingly known. Such optical devices can include head-mounted displays, near-eye displays with see-through glasses or other types of augmented reality. Contrary to virtual reality applications, augmented reality displays need a see-through functionality to allow the real world to be viewed at the same time as a virtual image. In optical devices for augmented reality, it is known to use an optical outcoupling component to couple light out of a waveguide device into air, for example into an eyebox. Thereto, the light beam should be expanded. It is known that photorefractive diffraction gratings may be used for this purpose, in particular holographic diffraction gratings. To arrive at a substantially uniform light distribution of the expanded beam in the eyebox, on the eye or on a screen, it is also known that an extraction efficiency of the outcoupling component should increase along the outcoupling component in a direction of light propagation. In particular, at an entrance side of the outcoupling component, only a small fraction of light should be outcoupled whereas a large fraction should be outcoupled towards an opposite end at distance of the entrance side.

However, due to the relatively small optical anisotropy of photorefractive material, such as material based on photopolymers, a relatively thick layer of material may be required, which may be disadvantageous for many types of applications. Moreover, wavelength dependency may be relatively strong in photorefractive material.

### SUMMARY OF THE INVENTION

It is therefore an aim of the present invention to solve or at least alleviate one or more of the above-mentioned problems. In particular, the invention aims at providing an improved optical outcoupling component, which can function as a beam expander while having a relatively limited thickness.

To this aim, according to a first aspect of the invention, there is provided an optical outcoupling component. In particular, the optical outcoupling component is configured to couple light out of a waveguide device into air, for example into an eyebox or into any other enlarged outcoupling region. The outcoupling component includes at least one substrate and at least one optically active layer. The substrate may be a planar substrate, or a curved substrate having a relatively small or limited curvature, which may improve optical quality. The at least one optically active layer includes first areas configured to transmit light, in particular perform waveguiding, without outcoupling, and second areas configured to outcouple at least part of the light. In other words, the first areas are neutral areas in which light continues to be propagated as in the waveguide, while light may be outcoupled in the second areas. In said second areas the at least one optically active layer is a chiral liquid crystal layer, the helical axis of the chiral liquid crystals being inclined with respect to said at least one substrate. In the present context, inclined is to be understood as not being perpendicular to, nor being in parallel with, said at least one substrate, so inclined with respect to a normal of the surface. As a result, incident light on the at least one chiral liquid crystal layer with inclined helical axis changes its direction such that light is outcoupled. In an inventive way, the at least one optically active layer includes a discrete alternation of said first areas and said second areas in a direction of propagation of light. In other words, the at least one optically active layer including the first areas and the second areas form a discontinuous or intermittent diffractive grating, in which ‘neutral’ first areas are alternating with light outcoupling second areas. Thanks to the presence of first areas in the at least one optically active layer, outcoupling in a relatively narrow region, for example about a size of a thickness of the at least one substrate, can be avoided. Thanks to the use of a chiral liquid crystal layer in the second areas with helical axis of the chiral liquid crystals being inclined with respect to said at least one substrate, the optical outcoupling component can function as a relatively efficient beam expander while being made relatively thin.

A spatial distribution of the first areas and the second areas can advantageously vary in the direction of propagation of light. Spatial distribution can for example include a length in a direction of propagation of light of said first areas or said second areas. Additionally, and/or alternatively, a spatial distribution can include a width in a direction transverse to the direction of propagation of light. A length and/or a width of first areas and of second areas may vary in the direction of propagation of light. Additionally, and/or alternatively, spatial distribution can include a number of second areas per surface unit, which may vary in the direction of propagation of light. Said varying spatial distribution in the direction of propagation of light can allow a varying portion of light being outcoupled.

More preferably, a ratio of the surface area of the first areas to a surface area of the second areas can decrease in the direction of propagation of light in the waveguide device. In other words, towards a light entrance side, where light arrives from a waveguide, the at least one optically active layer comprises a relatively high amount of surface area of first areas and a relatively low portion of second area surface area, whereas towards a second end, opposite the light entrance side in the direction of propagation of light, of the optical outcoupling component, a surface area of second areas increases with respect to the first areas. This decrease in surface area ratio can result in a higher percentage of light being outcoupled towards said second end and a smaller percentage of light being outcoupled at the light entrance side. In this way, a relatively uniform light distribution towards an eye can be obtained.

The at least one optically active layer in said first areas can advantageously be a chiral liquid crystal layer, in which a helical axis of the chiral liquid crystals of said first areas is normal to the at least one substrate. When the helical axis of the chiral liquid crystals is normal to the at least one substrate, in other words, when the helical axis of the chiral liquid crystals is substantially in parallel to a normal direction to said at least one substrate or when the liquid chiral director is thus substantially in parallel to the at least one substrate, light will be transmitted, in particular continuously waveguided, by the at least one optically active layer instead of being outcoupled. By using a chiral liquid crystal layer in said first areas, the entire active layer can be a chiral liquid crystal layer, in which the difference between said first areas and said second areas is obtained by a difference in angle between the helical axis and a normal to the at least one substrate. Alternatively, a chiral liquid crystal layer may be used for another bandgap than the one which can reflect and outcouple the transmitted light. Still alternatively, other materials, such as for example an isotropic material, may be used for said first areas of the at least one optically active layer. The person skilled in the art will understand that there are various ways to obtain light transmission, in particular continuous waveguiding of light, instead of outcoupling in the first areas of the at least one optically active layer.

A thickness of the at least one optically active layer can preferably remain constant, in particular, in a direction of propagation of light. A thickness of a chiral liquid crystal layer can preferably be comprised in a range of more or less 2 to more or less 20 μm. Manufacturing an optically active layer having a constant thickness, in particular in the order of magnitude of micrometres, may be relatively easy. Moreover, a relatively thin chiral liquid crystal layer can have very low haze and can improve quality of a transmitted image. In case the at least one optically active layer includes an isotropic material for the first areas, then a volume, in particular of said first areas, would be filled with said isotropic material and the chiral liquid crystal areas of the second areas would be islands or droplets of chiral liquid crystal, also having a thickness in a range of more or less 2 to more or less 20 μm.

The at least one optically active layer may preferably include a single chiral liquid crystal material. When a single chiral liquid crystal material is used for the entire optically active layer, the pitch will remain constant due to the same chemical composition of the layer. Alternatively, in particular in the case of second areas being islands within an isotropic material, a plurality of chiral liquid crystal materials may be used, each having a different pitch, such that each of said different chiral liquid crystal materials may be configured to outcouple a different colour of light.

The at least one optically active layer can advantageously be a plurality of chiral liquid crystal layers, each chiral liquid crystal layer of said plurality of chiral liquid crystal layers having a different pitch and being configured to reflect and outcouple light of a different colour. In this way, light including various colours can be outcoupled in an optimal way. The different chiral liquid crystal materials of said plurality of chiral liquid crystal layers may be based on different liquid crystal mixtures and can be deposited on top of each other in consecutive steps, with or without intermediate alignment layers in between said different liquid crystal layers. Since a total thickness of a single optically active layer is preferably comprised in a range of more or less 2 to more or less 20 μm, a total thickness of a plurality of chiral liquid crystal layers may be a multiple of said range, depending on the number of optically active layers.

Said second areas can include a plurality of different chiral liquid crystal layers, each chiral liquid crystal layer being configured to reflect and outcouple light of a different colour. Such a plurality of chiral liquid crystal layers can for example each have a relatively narrow reflection band, but the plurality of chiral liquid crystal layers can together increase outcoupling of light of for example red, green and blue wavelengths compared to a single chiral liquid crystal material having a broad spectral reflection band. However, deposition of three chiral liquid crystal layers may be more complicated than deposition of a single chiral liquid crystal layer.

According to a further aspect of the invention, there is provided a waveguide device. Such a waveguide device can provide one or more of the above-mentioned advantages.

It may be preferred that the in-coupling component of the waveguide device includes at least one substrate and at least one optically active layer. The at least one optically active layer may for example include a chiral liquid crystal layer, the helical axis of the chiral liquid crystals being inclined with respect to said at least one substrate by an inclination angle which is opposite of an inclination angle between the helical axis of the chiral liquid crystals of the second areas of the at least one optically active layer of the outcoupling component. In particular, this may be obtained by a left tilt for the helical axis in one of the in-coupling and outcoupling component in contrast to a right tilt in the other of the in-coupling and outcoupling component. In this way, input angles and output angles of light may be substantially equal, which can be useful in Augmented Reality applications. In particular, a pixel may correspond to a direction for the eye of a user. Alternatively, opposite inclination angles between the in-coupling component and the outcoupling component may also be obtained in other ways than with the aid of chiral liquid crystal layers.

According to a further aspect of the invention, there is provided a method for manufacturing an optical outcoupling component. In particular, the method comprises the steps of providing at least one substrate, depositing a photoalignment layer on at least part of the at least one substrate, illuminating predetermined areas of the photoalignment layer with light polarized in a variable orientation and providing at least one optically active layer on the photoalignment layer, said at least one optically active layer being at least one chiral liquid crystal layer in at least said predetermined areas. The step of illuminating predetermined areas of the photoalignment layer with light polarized in a variable orientation, for example by interference between two inclined coherent beams with opposite circular polarization, causes a helical axis of the chiral liquid crystals of the at least one chiral liquid crystal layer to be inclined with respect to said at least one substrate. The step of illuminating predetermined areas of the photoalignment layer with light polarized in a variable orientation thus results in the at least one optically active layer including a discrete alternation of first areas configured to transmit light without outcoupling and second areas configured to outcouple at least part of the light, the second areas of the at least one optically active layer corresponding to the predetermined areas of the photoalignment layer. The method can provide one or more of the above-mentioned advantages. In particular, the method may be relatively cost-efficient. As an alternative to causing a helical axis of the chiral liquid crystal layer of the second areas to incline via illumination of the predetermined areas of the photoalignment layer by variably oriented polarized light, structured alignment by nano-imprint with a stamp may be used, in which case production of the stamp may be relatively difficult.

The step of illuminating predetermined areas of the photoalignment layer may for example include providing a mask including variations in transparency corresponding to said discrete alternation of first areas and of second areas of the at least one optically active layer. As an alternative, a field with variable intensity and polarization can be created by a spatial light modulator (SLM). The light from the SLM may be projected onto the substrate. Although a mask is manufactured for a specific pattern of said discrete alternation while a spatial light modulator can be programmed to modify a pattern of said discrete alternation, a mask may be more cost-efficient for mass production.

The method may further include the step of illuminating with homogeneously polarized light areas outside the predetermined areas of the photoalignment layer, causing a helical axis of the chiral liquid crystals of the at least one chiral liquid crystal layer to be normal to said at least one substrate. Homogeneously polarized light is to be understood as light having the same polarization over a certain area. An order of illumination of the photoalignment layer with variably oriented polarized light and with homogeneously polarized light is of minor importance and can be inversed. The photoalignment layer may for example first be illuminated with variably oriented polarized light, and in a second step with homogeneously polarized light. In that case, not only predetermined areas of the photoalignment layer, but the entire photoalignment layer, may be illuminated with variably oriented polarized light while the discrete alternation of first and second areas may be obtained in the second step by illuminating with homogeneously polarized light areas outside the predetermined areas of the photoalignment layer, thus ‘overwriting’the effect of the first illumination step.

The step of providing at least one chiral liquid crystal layer on the photoalignment layer may preferably include polymerizing said at least one chiral liquid crystal layer after deposition to obtain at least one solid liquid crystal layer. In this way, the at least one liquid crystal layer can become stable with respect to for example external forces or temperature variations. The polymerizing of said at least one chiral liquid crystal layer after deposition may be limited to some areas or may even be droplets.

The step of providing at least one chiral liquid crystal layer on the photoalignment layer may advantageously include depositing three layers of chiral liquid crystals, each layer including a different chiral liquid crystal, each being configured to outcouple light of a different colour, which can improve outcoupling of light of various wavelengths. Each chiral liquid crystal material can for example be chosen to reflect only a narrow wavelength range, such as red, green or blue emission from a LED light source rather than a material configured to reflect a broad wavelength range.

### BRIEF DESCRIPTION OF THE DRAWINGS

FIG. 1 shows a schematic view of an embodiment of a waveguide device according to an aspect of the invention;

FIG. 2 shows a schematic view of a waveguide device including a first embodiment of an optical outcoupling component according to an aspect of the invention;

FIG. 3 shows a schematic view of a waveguide device including a second embodiment of an optical outcoupling component according to an aspect of the invention;

FIG. 4 shows a schematic view of a waveguide device including a third embodiment of an optical outcoupling component according to an aspect of the invention;

FIG. 5 shows a schematic view of a waveguide device including a fourth embodiment of an optical outcoupling component according to an aspect of the invention;

FIG. 6 shows a schematic view of a waveguide device including a fifth embodiment of an optical outcoupling component according to an aspect of the invention;

FIG. 7 shows a schematic view of a waveguide device including a sixth embodiment of an optical outcoupling component according to an aspect of the invention.

### DETAILED DESCRIPTION OF EMBODIMENT(S)

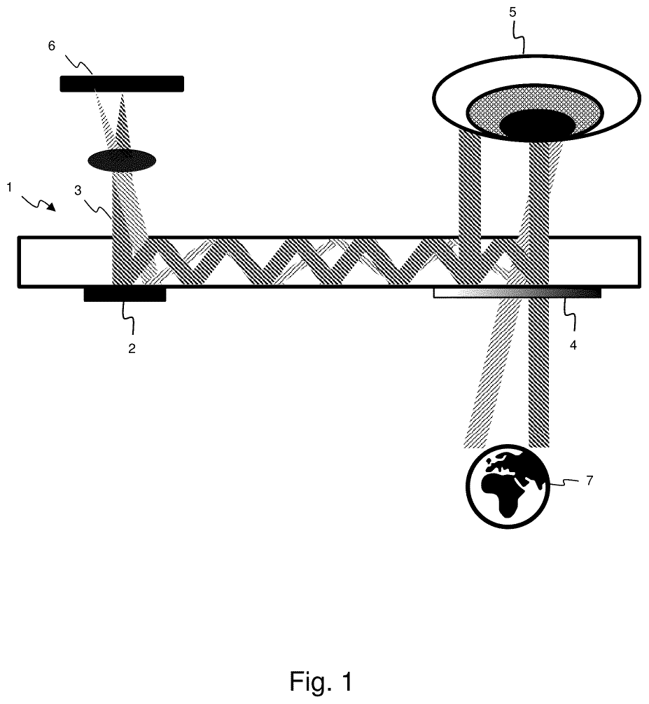

FIG. 1 shows a schematic view of an embodiment of a waveguide device 1 according to an aspect of the invention. The waveguide device 1 may be in particular suitable to be used for augmented reality, for example for head-mounted displays, near-eye displays with see-through glasses or for other augmented reality applications. The waveguide device 1 comprises an in-coupling component 2 configured to couple light 3 into the waveguiding device 1 and an optical outcoupling component 4 configured to couple light 3 out of the waveguide device 1 into air, for example towards an eye 5 or an eyebox. The light 3 may for example come from a display 6, and may include a plurality of wavelengths, which are guided along different paths within the waveguide device 1. For augmented reality applications, the waveguide device preferably includes a see-through functionality such that the eye 5 is also allowed to see the real world 7 simultaneously with a virtual image projected onto the eye via the waveguide device. To arrive at a substantially uniform light distribution of the expanded beam on the eye 5 or on a screen, it is desirable that at an entrance side of the outcoupling component 4, only a small fraction of light should be outcoupled whereas a large fraction should be outcoupled towards an opposite end at distance of the entrance side.

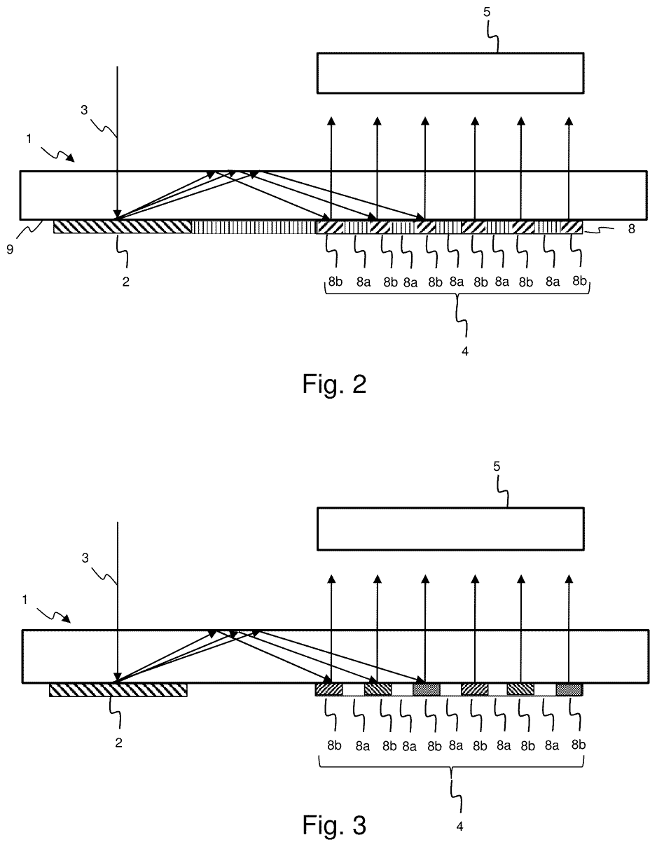

Thereto, FIG. 2 shows a schematic view of a waveguide device including a first embodiment of an optical outcoupling component according to an aspect of the invention. The outcoupling component 4 includes at least one substrate 9 and at least one optically active layer, for example a single optically active layer 8. Said optically active layer 8 includes first areas 8a configured to transmit light without outcoupling, and second areas configured to outcouple at least part of the light. The optically active layer 8 includes a discrete alternation of said first areas 8a and said second areas 8b in a direction of propagation of light. In other words, said first areas 8a and second areas 8b are alternating in a direction of propagation of light. The optically active layer 8 may for example be a chiral liquid crystal layer, for example of a single chiral liquid crystal material such that a pitch is constant over the optically active layer. In the first areas 8a, a helical axis of the chiral liquid crystals is substantially transverse to the substrate, in other words substantially in parallel to a normal direction to said at least one substrate, such that light is transmitted without being outcoupled, whereas the helical axis of the chiral liquid crystals of the second areas 8b is inclined with respect to a normal direction to said at least one substrate such that light is outcoupled. Using a chiral liquid crystal layer can allow to obtain a relatively large refractive index anisotropy, for example comprised between more or less 0.1 and 0.4, preferably around 0.2. Moreover, the chiral liquid crystal layer can be made relatively thin, for example only a few micrometres while providing relatively efficient light reflection. A single chiral liquid crystal material can further provide a relatively broad range of wavelength reflection. The in-coupling component 2 of the waveguide device 1 may also include at least one substrate and at least one optically active layer. In the embodiment of FIG. 2, the in-coupling component 2 includes one optically active layer which is a single chiral liquid crystal layer, which is preferably a single layer over the entire waveguide device, in particular the same as in the outcoupling component. The helical axis of the chiral liquid crystals in the in-coupling component are inclined with respect to said at least one substrate by an inclination angle which is opposite of an inclination angle between the helical axis of the chiral liquid crystals of the second areas 8b of the optically active layer 8 of the outcoupling component 4. In particular, this may be obtained by a left tilt for the helical axis in one of the in-coupling and outcoupling component in contrast to a right tilt in the other of the in-coupling and outcoupling component. Alternatively, the in-coupling component 2 of the waveguide device 1 may be of any other known type.

FIG. 3 shows a schematic view of a waveguide device including a second embodiment of an optical outcoupling component according to an aspect of the invention. In contrast to the preceding embodiment, the first areas 8a of the optically active layer 8 do not include a chiral liquid crystal material but rather include other materials, such as for example an isotropic material which is configured to waveguide light without outcoupling said light. The present embodiment further differs in that the second areas 8b can include a plurality of different chiral liquid crystal materials, each chiral liquid crystal material being configured to reflect and outcouple light of a different colour. Each chiral liquid crystal material can for example have a relatively narrow reflection band, for example for red, green and blue wavelengths, but the plurality of chiral liquid crystal materials can together increase outcoupling of light compared to a single chiral liquid crystal material having a broad spectral reflection band. The in-coupling component 2 may be similar to what is described for FIG. 2 and may for example include a chiral liquid crystal material having a broad spectral reflection band.

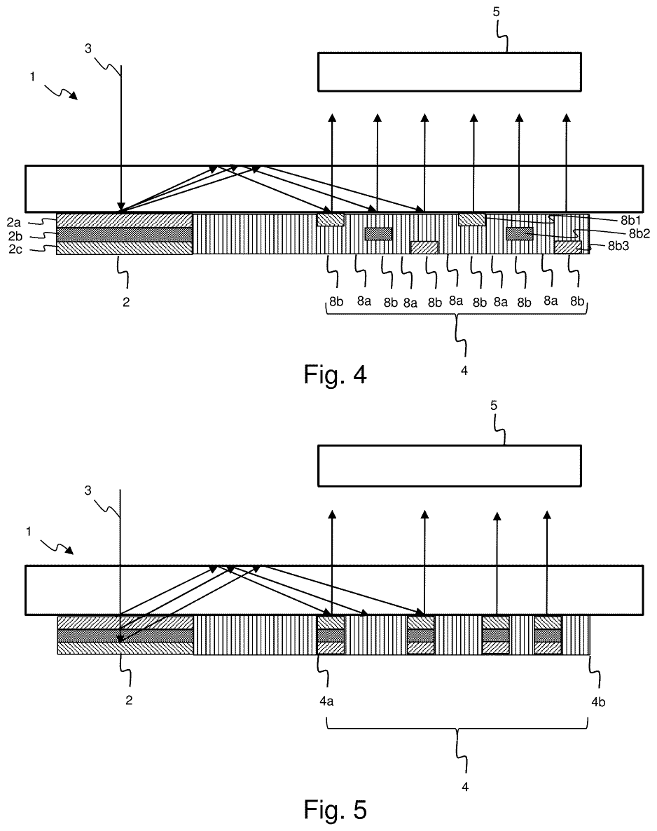

FIG. 4 shows a schematic view of a waveguide device including a third embodiment of an optical outcoupling component according to an aspect of the invention. In the present embodiment, the second areas 8b optically active layer include a plurality of, in particular three, chiral liquid crystal layers 8b1, 8b2, 8b3, each chiral liquid crystal layer of said plurality of chiral liquid crystal layers having a different pitch and being configured to reflect and outcouple light of a different colour, for example each layer being configured to reflect a narrow band of blue, green or red wavelength. The first areas 8a may also include a chiral liquid crystal layer, but a helical axis of the chiral liquid crystals is substantially transverse or perpendicular to the substrate such that light is transmitted without being outcoupled, whereas the helical axis of the chiral liquid crystals of the second areas 8b is inclined with respect to a normal direction to said at least one substrate such that light is outcoupled. Alternatively, an isotropic material may be used for the first areas 8a. The in-coupling component 2 may also include a plurality of chiral liquid crystal layers, for example three chiral liquid crystal layers 2a, 2b, 2c, which may each be configured to reflect light of a different wavelength, preferably in a narrow band of for example, red, green and blue. In analogy with the embodiments described under FIG. 2 or 3, the helical axis of the chiral liquid crystals per layer of the in-coupling component 2 are preferably inclined with respect to said at least one substrate by an inclination angle which is opposite of an inclination angle between the helical axis of the chiral liquid crystals of the second areas 8b of the optically active layers 8b1, 8b2, 8b3 of the outcoupling component 4.

FIG. 5 shows a schematic view of a waveguide device including a fourth embodiment of an optical outcoupling component according to an aspect of the invention. In contrast to the embodiment of FIG. 5, the different chiral liquid crystal materials of said three chiral liquid crystal layers 8b1, 8b2, 8b3 of the outcoupling component 4 can be deposited on top of each other in consecutive steps. The different chiral liquid crystal materials may for example be based on different liquid crystal mixtures. Again, each of the three chiral liquid crystal layers may be configured reflect a narrow band of blue, green or red reflection. Contrary to the previous embodiments, a spatial distribution of the first areas 8a and the second areas 8b can advantageously vary in the direction of propagation of light. Spatial distribution can for example include a length in a direction of propagation of light of said first areas or said second areas. Additionally, and/or alternatively, a spatial distribution can include a width in a direction transverse to the direction of propagation of light. In the present embodiment, the distance between the outcoupling zones, i.e. the second areas 8b decreases in a direction of propagation of light, which is from left to right on FIG. 5. In other words, towards a light entrance side 4a, where light arrives in the outcoupling component 4 coming from the in-coupling component 2 via waveguiding, the at least one optically active layer 8 comprises a relatively high amount of surface area of first areas 8a and a relatively low portion of second area 8b surface area, whereas towards a second end 4b of the outcoupling component 4, opposite the light entrance side 4a in the direction of propagation of light, a surface area of second areas 8b increases with respect to the first areas 8a. At a light entrance side 4a, the helical axis of the chiral liquid crystals is mostly perpendicular to the substrate, corresponding to a relatively large surface area of first areas 8a, so that the waveguiding is largely maintained. For a small fraction, the helical axis of the chiral liquid crystals is inclined with respect a normal to said substrate, corresponding to a relatively small surface area of second areas 8b, such that light is reflected on the diffraction grating formed by the chiral liquid crystal layer and outcoupled. Towards the second end 4b of the outcoupling component 4, most of the chiral liquid crystal layer has a tilted helical axis such that most light is subjected to reflection by the grating. This decrease in surface area ratio of first areas 8a to second areas 8b can result in a higher amount of light being outcoupled towards said second end 4b and less light being outcoupled at the light entrance side 4a.

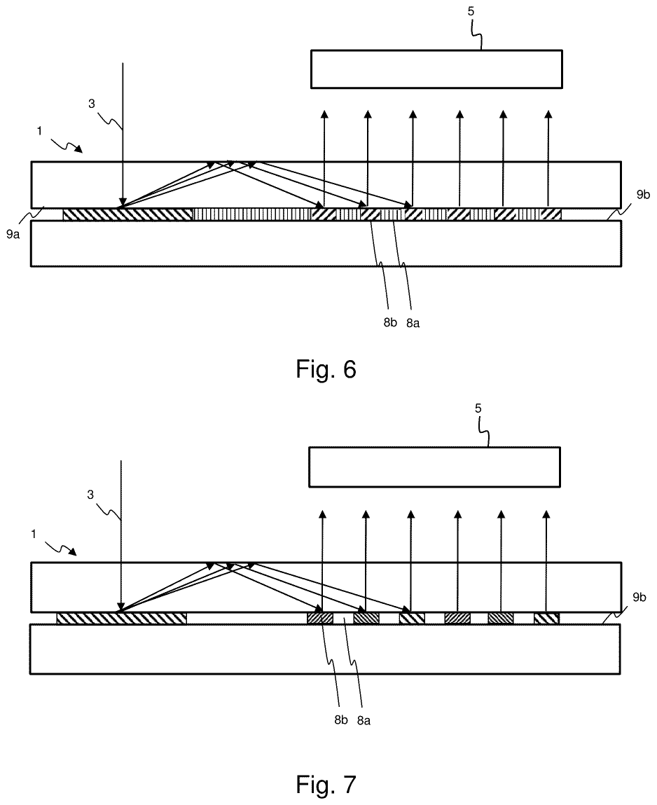

FIG. 6 shows a schematic view of a waveguide device including a fifth embodiment of an optical outcoupling component according to an aspect of the invention. The present embodiment is substantially the same as the embodiment shown in FIG. 2, except that the waveguide device 1 includes two substrates 9a, 9b and that the optically active layer is positioned in between said two substrates 9a, 9b. When manufacturing such an optical outcoupling component 4, the two substrates may be coated with a photoalignment layer. Then the photoalignment layer may be illuminated with two circularly polarized laser beam yielding a continuous rotation of the azimuthal angle to create said second areas 8b of the chiral liquid crystal layer. Then the photoalignment layer may again be illuminated, but with a homogeneous polarization to obtain a homogeneous alignment of the photoalignment layer. This is done through a mask, which is preferably mostly transparent near an entrance side 4a of the outcoupling component, and which has only relatively small transparent areas near the second end 4b, to obtain a decrease in surface area ratio of first areas 8a to second areas 8b as described with respect to FIG. 5. The space between the two substrates 9a, 9b may then be filled with a chiral liquid crystal with a given pitch. The helical axis of said chiral liquid crystal will then form under influence of the photoalignment layer.

FIG. 7 shows a schematic view of a waveguide device including a sixth embodiment of an optical outcoupling component according to an aspect of the invention. This embodiment largely corresponds to what is described for FIG. 3 except that there are now two substrates 9a, 9b. In between said two substrates 9a, 9b, there is a layer of isotropic material as first areas 8a. The isotropic material can be made from a liquid that is printed in a pattern and then polymerized. The second substrate 9b can be pressed on the first one 9a, with spacers to fix a thickness of the optically active layer. The open spaces created by the pattern can then be filled as capillaries with chiral liquid crystals from a side. Other manufacturing ways are possible as well, such as for example printing of the polymerizable chiral liquid crystals. Different types of chiral liquid crystals may be used, which may each be configured to reflect a different wavelength, as previously described for FIG. 3.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-15. (canceled)

16. An optical outcoupling component configured to couple light out of a waveguide device,
wherein the outcoupling component includes at least one substrate and at least one optically active layer,
wherein the at least one optically active layer includes first areas configured to transmit light without outcoupling, and second areas configured to outcouple at least part of the light,
wherein in said second areas the at least one optically active layer is a chiral liquid crystal layer, the helical axis of the chiral liquid crystals being inclined with respect to said at least one substrate,
wherein the at least one optically active layer includes a discrete alternation of said first areas and said second areas in a direction of propagation of light.

17. The optical outcoupling component according to claim 16, wherein a spatial distribution of the first areas and the second areas varies in the direction of propagation of light.

18. The optical outcoupling component according to claim 16, wherein a ratio of the surface area of the first areas to a surface area of the second areas decreases in the direction of propagation of light in the waveguide device.

19. The optical outcoupling component according to claim 16, wherein the at least one optically active layer in said first areas is a chiral liquid crystal layer and wherein a helical axis of the chiral liquid crystals of said first areas is normal to the at least one substrate.

20. The optical outcoupling component according to claim 16, wherein a thickness of the at least one optically active layer remains constant.

21. The optical outcoupling component according to claim 16, wherein the at least one optically active layer includes a single chiral liquid crystal material.

22. The optical outcoupling component according to claim 16, wherein the at least one optically active layer is a plurality of chiral liquid crystal layers, each chiral liquid crystal layer of said plurality of chiral liquid crystal layers being configured to reflect and outcouple light of a different colour.

23. The optical outcoupling component according to claim 16, wherein said second areas include a plurality of different chiral liquid crystals, each chiral liquid crystal being configured to reflect and outcouple light of a different colour.

24. A waveguide device, in particular for augmented reality, comprising an in-coupling component configured to couple light into the waveguiding device and an optical outcoupling component according to claim 16.

25. The waveguide device according to claim 24, wherein the in-coupling component includes at least one substrate and at least one optically active layer, wherein the at least one optically active layer is a chiral liquid crystal layer, the helical axis of the chiral liquid crystals being inclined with respect to said at least one substrate by an inclination angle which is opposite of an inclination angle between the helical axis of the chiral liquid crystals of the second areas of the at least one optically active layer of the outcoupling component.

26. A method for manufacturing an optical outcoupling component, in particular an optical outcoupling component according to claim 16, including the steps of:
(a) providing at least one substrate;
(b) depositing a photoalignment layer on at least part of the at least one substrate;
(c) Illuminating predetermined areas of the photoalignment layer with light polarized in a variable orientation;
(d) Providing at least one optically active layer on the photoalignment layer, said at least one optically active layer being at least one chiral liquid crystal layer in at least said predetermined areas;
wherein the step of illuminating predetermined areas of the photoalignment layer with light polarized in a variable orientation causes a helical axis of the chiral liquid crystals of the at least one chiral liquid crystal layer to be inclined with respect to said at least one substrate, and
wherein the step of illuminating predetermined areas of the photoalignment layer with light polarized in a variable orientation results in the at least one optically active layer including a discrete alternation of first areas configured to transmit light without outcoupling and second areas configured to outcouple at least part of the light in a direction of propagation of light, the second areas of the at least one optically active layer corresponding to the predetermined areas of the photoalignment layer.

27. The method according to claim 26, wherein the step of illuminating predetermined areas of the photoalignment layer includes providing a mask including variations in transparency corresponding to said discrete alternation of first areas and of second areas of the at least one optically active layer.

28. The method according to claim 26, further including the step of illuminating with homogeneously polarized light areas outside the predetermined areas of the photoalignment layer, causing a helical axis of the chiral liquid crystals of the at least one chiral liquid crystal layer to be normal to said at least one substrate.

29. The method according to claim 26, wherein the step of providing at least one chiral liquid crystal layer on the photoalignment layer includes polymerizing said at least one chiral liquid crystal layer after deposition to obtain at least one solid liquid crystal layer.

30. The method according to claim 26, wherein the step of providing at least one chiral liquid crystal layer on the photoalignment layer includes depositing three layers of chiral liquid crystals, each layer including a different chiral liquid crystal, each being configured to outcouple light of a different colour.
